(19) United States
(12) Patent Application Publication
(10) Pub. No.: US 2008/0176041 A1
(43) Pub. Date: Jul. 24, 2008

(54) Resin Film Substrate for Organic Electroluminescence and Organic Electroluminescence Device

(75) Inventors: Akira Sato, Tokyo (JP); Shigeto Hirabayashi, Tokyo (JP); Tomoyuki Nakayama, Tokyo (JP); Hiroshi Kita, Tokyo (JP); Kazuhiro Fukuda, Tokyo (JP); Toshihiro Takahata, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA HOLDINGS, INC, Tokyo (JP)

(21) Appl. No.: 11/885,811

(22) PCT Filed: Mar. 1, 2006
(86) PCT No.: PCT/JP2006/303836

§ 371 Date: Sep. 6, 2007

(30) Foreign Application Priority Data
Mar. 10, 2005 (JP) 2005-066871

(51) Int. Cl. B32B 3/00; B32B 9/04

(52) U.S. Cl. 428/161; 428/172; 428/411.1

(57) ABSTRACT

Disclosed is a low-cost resin film substrate for organic electroluminescence which comprises a gas barrier layer having high gas barrier properties while being improved in light taking-out efficiency. Also disclosed is an organic electroluminescence device using such a resin film substrate. Specifically disclosed is a resin film substrate for organic electroluminescence comprising at least one gas barrier layer on a resin film. This resin Film substrate is characterized in that the surface of the outermost layer on the side having the gas barrier layer has a concavo-convex structure for diffracting of diffusing light.

### TECHNICAL FIELD

The present invention relates to a resin film substrate for organic electroluminescence and an organic electroluminescence device using the organic film substrate.

### BACKGROUND ART

In organic electroluminescence using a film substrate (also called organic EL hereinafter) light emitting device, there is a problem in that the light taking-out efficiency is low. Due to the effect of the refractive index of the light-emitting body, if the refractive index of the light emitting layer is, for example, 1.6-1.7, no more than about 20% of the total amount of emitted light can be taken out and most of the emitted light is totally reflected at the interface formed between the substrate and the light emitting layer for example and is trapped in the layer.

A method of providing a structure for diffracting light at the total reflection interface has been proposed as a means for improving light taking-out efficiency (Patent Document 1).

In addition, a method has been proposed in which random concavities and convexities are formed on the substrate or a transparent intermediate layer provided on the and a transparent electrode, an organic layer as well as another electrode are formed thereon (Patent Documents 2 and 3).

In addition, using a sheet which disperses light has also been proposed (Patent Document 4). Furthermore, a method is known in which light taking-out efficiency is improved due to a structure comprising a transparent electrode film which contacts one surface of a low refractive index member (see Patent Document 5). A method is also known in which the taking-out efficiency is improved by providing a low refraction index layer and a hard coat layer that has concavities and convexities for dispersing light between the light emitting layer including ITO and the substrate (see Patent Document 6).

Meanwhile, the organic EL device is highly sensitive to moisture and gases such as oxygen and the like, and this has a significant effect on the service life of the organic EL device. Because the resin film substrate has low gas barrier properties against moisture and oxygen, a gas barrier layer must be formed when using the film substrate in order to prevent affection of moisture and gases such as oxygen.

There are problems that providing, in addition to the gas barrier layer, a layer which improves the light taking-out efficiency increases cost, or product quality may be reduced due to increasing of the process steps.

Patent Document 1: Unexamined Japanese Patent Application Publication No. He10-81860

Patent Document 2: Unexamined Japanese Patent Application Publication No. H1-186588

Patent Document 3: Japanese Patent No. 3496492

Patent Document 4: Japanese Patent No. 2931211

### DISCLOSURES OF INVENTION

### Object of Invention

The present invention was conceived in view of the foregoing problems, and an object thereof is to provide a resin film substrate for organic electroluminescence and an organic electroluminescence device which simultaneously achieves improved function and low cost by giving a structure wherein, in the resin film substrate for organic electroluminescence comprising at least one gas barrier layer, the gas barrier layer or the layer adjacent to the gas barrier layer includes a light taking-out function.

### Means for Solving the Object

The foregoing objects of the present invention are achieved by the following structures.

1. A resin film substrate for organic electroluminescence comprising at least one gas barrier layer on a resin film, wherein the surface of the outermost layer on the side having the gas barrier layer has a concavo-convex structure for diffracting or diffusing light.

2. A resin film substrate for organic electroluminescence comprising at least one gas barrier layer on a resin film, wherein the outermost layer on the side having the gas barrier layer includes a layer which diffracts or diffuses light.

3. The resin film substrate for organic electroluminescence of 1 or 2, wherein the outermost layer on the side having the gas barrier layer includes a low refractive index layer having a refractive index no greater than 1.50 and no less than 1.03 and a thickness no less than 0.3 μm.

4. A resin film substrate for organic electroluminescence comprising at least one gas barrier layer on a resin film, wherein the outermost layer on the side having the gas barrier layer is a high refractive index layer having a refractive index no less than 1.45 and no greater that 2.10, and a concavo-convex structure for diffracting or electroluminescent layer and a metal electrode in the listed order on the resin film substrate for organic electroluminescence of any of 1 to 6.

### EFFECTS OF THE INVENTION

The present invention provides a low cost resin film substrate for organic electroluminescence comprising a gas barrier which has high gas barrier properties and in which light taking-out properties are improved, as well as an organic electroluminescence device which uses the resin film substrate for organic electroluminescence.

### BRIEF DESCRIPTION OF THE DRAWINGS

FIG. 1 shows an example of a cross-section of the resin film substrate for organic electroluminescence having a laminate structure in which the gas barrier layer and the stress relief layer are combined.

FIG. 2 shows an example of the concavo-convex structure which functions as a diffraction grating.

FIG. 3 is a cross-sectional structural view showing an example of the resin film substrate for organic electroluminescence in which a light diffracting structure is provided on the surface of the stress relief layer on the gas barrier layer.

FIG. 4 is a cross-sectional structural view showing an example of the resin film substrate for organic electroluminescence in which the surface of the stress relief layer on the gas barrier layer is a diffusing structure which diffuses light.

FIG. 5 is a cross-sectional structural view showing an example of the resin film substrate for organic electroluminescence in which a diffusion layer which is also a stress relief layer is provided on the outermost surface.

FIG. 6 is a cross-sectional view showing an example of the resin film substrate for organic electroluminescence comprising a gas barrier layer formed of a high refractive index material is formed on the outermost surface on the diffraction structure.

FIG. 7 is a cross-sectional view showing an example of the resin film substrate for organic electroluminescence in which the light diffusing layer, which is also the stress relief layer, is provided directly under the outermost gas barrier layer.

FIG. 8 shows an example of the cross-sectional structure in pattern form of the organic electroluminescence device in which an organic electroluminescence element is formed and sealed on the resin film substrate for organic electroluminescence of the present invention.

### LEGEND

1 Resin film substrate
3 Gas barrier layer
4 Stress relief layer
5 Anode (ITO)
6 Organic EL layers
7 Cathode
8 Gas barrier film
9 Adhesive

### BEST MODE FOR CARRYING OUT THE INVENTION

The following is a detailed description of the preferred embodiments of the present invention.

The resin film substrate for organic electroluminescence of the present invention uses a plastic film (resin film) as the substrate and this is preferable because it is lighter and more plastic and flexible than the conventional glass substrates. However, the resin film has inferior gas barrier properties against water vapor, oxygen and the like when compared with those of glass and the like, and thus a resin film substrate for replacing glass that has gas barrier properties on a par with that of glass is being developed. The resin film substrate for organic EL of the present invention was conceived in order to simultaneously improve gas barrier properties and to improve the light taking-out effect which is a big problem in the field of organic EL element.

The present invention relates to resin film substrate for organic EL in which both a gas barrier layer and a structure for diffracting or diffusing light are introduced, and gas barrier properties and light taking-out properties are simultaneously improved.

In the present invention, the gas barrier layer is a layer formed from material in which the water vapor permeability coefficient is 1×10⁻⁶ g·m/m²/day-1×10⁻¹ g·m/m²/day, the oxygen permeability coefficient is 1×10⁻⁴ ml·m/m²/day-1×10⁻¹ ml·m/m²/day, and as a result, by forming the gas barrier layer, a gas barrier film with excellent gas barrier properties can be obtained in which the water vapor permeability rate measured in accordance with the JIS K7129 B method is 0.1 g/m²/day or less and more preferably 0.01 g/m²/day or less, while the oxygen permeability rate is 0.1 ml/m²/day and more preferably 0.01 ml/m²/day or less in the prepared resin film substrate.

No particular limitation is imposed on the composition and the like of the gas barrier layer of the present invention as long as it blocks permeation of oxygen and water vapor. However, the material forming the gas barrier layer (film) of the present invention is preferably, ceramic films of metal oxides, metal nitrides, metal sulfides, metal carbides and the like, and more specifically inorganic oxides are more preferable, and examples include silicon oxide, aluminum oxide, silicon nitride, silicon oxynitride, aluminum oxynitride, magnesium oxide, zinc oxide, indium oxide, tin oxide and the like, and ceramic films of silicon oxide, silicon nitride, silicon oxynitride, aluminum oxide, aluminum oxynitride and the like are particularly preferable.

In the present invention, no particular limitation is imposed on the method for manufacturing the ceramic film, and examples include a method in which the ceramic film is formed by a wet method such as the sol-gel method and the like using an alkoxy of silicon or titan as the metal oxide material, but it may also be formed using the sputtering method, the ion assist method, or the plasma CVD method and the plasma CVD method under atmospheric pressure or near-atmospheric pressure which are described hereinafter.

In wet methods such as the sol-gel method which uses spraying or spray coating, obtaining molecular level (nm level) smoothness is difficult, and because a solvent is used, in the case where the substrate which is an organic material, there is a shortcoming that materials or solvents that can be used are limited. Thus, a film that is formed using the plasma CVD method or the plasma CVD method under atmospheric pressure and near-atmospheric pressure which are described hereinafter is preferable. Of these the atmospheric plasma CVD method is preferable in view of the fact that a reduced pressure chamber and the like is unnecessary, high speed film formation is possible, and it is a high productivity film formation method.

The thickness of the ceramic film is preferably in the range of 5-2000 nm for use as a gas barrier layer. If the thickness of the gas barrier is less than 5 nm, there will be many film defects and sufficient damp proofing properties cannot be obtained. If the thickness of the film exceeds 2000 nm, the damp proofing properties are theoretically high, however, if it is too thick, there is a great amount of internal stress and breakage tends to occur. Thus prescribed damp proofing properties cannot be obtained, and it is difficult to maintain flexibility of the resin film substrate and there is the possibility that cracks and the like may occur in the gas barrier layer due to external factors such as bending and pulling after film formation.

The details of the film formation method using atmospheric pressure plasma CVD are described in Unexamined Japanese Patent Application Publication No. 2004-52028 and Unexamined Japanese Patent Application Publication No. 2004-198902, and organic metal compounds are used as raw materials, and the raw materials may be either in a gaseous, liquid or solid state at normal temperature and pressure. In the case where it is in a gaseous state, the gas is introduced as it is into the discharge space, but in the case where it is in a liquid or solid state, it is used after being gasified by means such as heating, bubbling, pressure reduction, ultrasonic wave irradiation or the like. Due to this situation, the organic metal compound is preferably a metal alkoxide which has a boiling point of 200° C. or less.

Examples of this metal alkoxide include: silicon compounds such as silane, tetramethoxy silane, tetraethoxy silane (TEOS), tetra-n propoxy silane; titanium compounds such as titanium methoxide, titanium ethoxide, titanium isopropoxide, titanium tetraisopropoxide; zirconium compounds such as zirconium n-propoxide; aluminium compounds such as aluminium ethoxide; aluminium triisopropoxide, aluminum isopropoxide and the like; and other examples are antimony ethoxide, arsenic triethoxide, zinc acetylacetate and diethyl zinc.

In addition, in order to obtain the inorganic material gas, cracked gas as well as the raw material gas containing these organic metal compound is used, and reactive gas is generated. Examples of these cracked gases include hydrogen gas and water vapor.

In the plasma CVD method, mainly discharge gases which achieve the plasma state easily are mixed with these reactive gases. Examples of the discharge gas include nitrogen gas, atoms in Group 18 of the periodic table such as helium, neon, argon and the like. Nitrogen is particularly favorable since the cost is low.

Film formation is performed by mixing the discharge gas and the reactive gas and supplying this gas mixture to the plasma discharge generator (plasma generator). The mixing ratio of the discharge gas and the reactive gas should be depending on the properties of the target film, but the reactive gas is supplied such that the proportion of the discharge gas is 50% or more of the total gas mixture.

If, for example, metal alkoxide or silicon alkoxide (tetraalkoxy silane (TEOS) having a boiling point of 200° C. or less is used as the raw material compound; oxygen is used as the cracked gas; an inert gas or an inactive gas such as nitrogen or the like is used as the discharge gas, and plasma discharge is carried out, then a silicon oxide film is generated which is favorable as the gas barrier film of the present invention.

In addition, in the present invention, the gas barrier film is preferably transparent. As a result, it becomes possible to be used as transparent substrates (that is to say, light take-out side substrates) for the organic EL element and the like. The light transmittance of the gas barrier film is preferably 80% or more and more preferably 90% or more when the measuring wavelength is 550 nm.

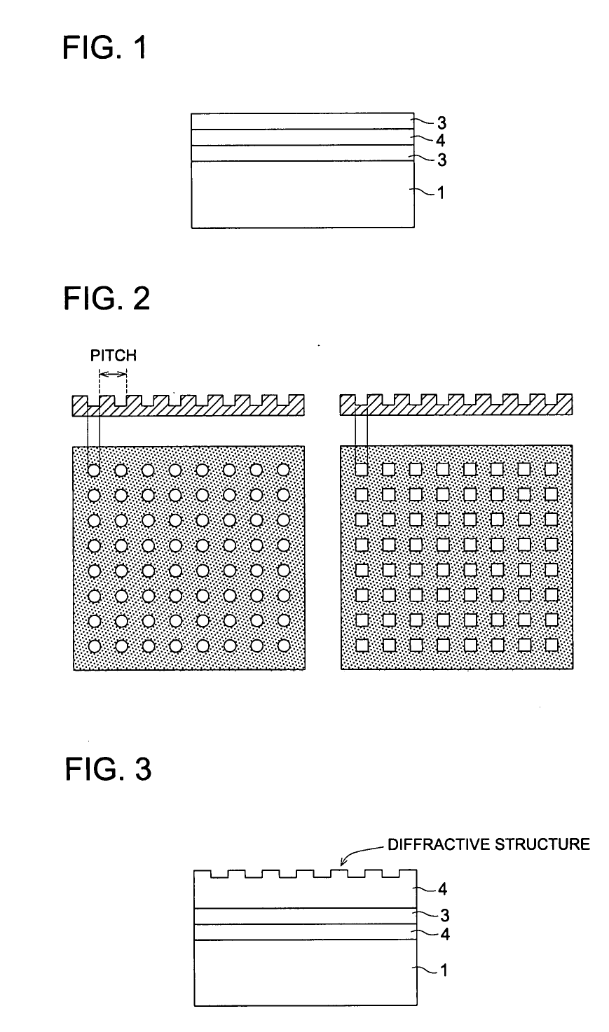

Because the ceramic film is closely packed and has a prescribed hardness, in order for the ceramic film to achieve prescribed gas barrier properties, it is preferable that the thickness of the gas barrier layer is set within the aforementioned range, and it is formed as a laminated structure of multiple layers in which a so-called stress relief layer is combined. FIG. 1 is a cross-sectional view showing the laminated structure formed of the gas barrier layers and the stress relief layers. For example, the gas barrier layer 3 is formed of a dense and hard ceramic resin such as silicon oxide, and the stress relief layer 4 is formed of a polymer layer which uses acrylic resins for example which are soft and can relieve stress. FIG. 1 shows a laminated structure in which the stress relief layer 4 is provided between two gas barrier layers on the resin film substrate 1. The stress relief layer can be any layer as long as it is more flexible than the gas barrier layers, and even silicon oxide can be used as long as is can be flexible by changing the film composition (for example the carbon concentration in the film).

Preferable examples of the resin material to be used in this type of stress relief layer include acrylic and methacrylic resins, polyolefin (PO) resins such as homopolymers or copolymers of ethylene, polypropylene, butene and the like; as well as polyethylene terephthalate and the like, but no particular limitation is imposed provided that the film is formed of an organic material that can hold the gas barrier layer.

In addition, the thickness of the stress relief layer is in the range of about 5-2000 nm and is selected along with the thickness of the gas barrier layer of the present invention in accordance with the required bending strength and flexibility.

No particular limitation is imposed on the resin film used in the resin film substrate for organic EL of the present invention, provided that it is a film substrate formed of an organic material that can hold the gas barrier layer that has the aforementioned gas barrier properties.

Specific examples include polyester based resins such a polyolefin (PO) resin, amorphous polyolefin resins (APO) such as cyclic polyolefin and the like, polyester based resins such as polyethylene terephthalate (PET), polyethylene 2,6-naphthalate (PEN), polyimide (PI) resins, polyether imide (PEI) resins, polysulfon (PS resins), polyether sulfon (PES) resins, polyether ether ketone (PEEK) resin, polycarbonate (PC) resin and the like. In addition, one or two of these resins may be laminated by means such as a laminating or coating means and used as a resin film substrate.

In the resin film substrate of the present invention, surface treatment such as corona treatment and the like may be performed in order to increase adhesion to the gas barrier layer and an adhesion layer and an anchor coating layer may be formed.

In addition, the thickness of the resin film substrate of the present invention, in the case of a film-like configuration, is preferably 10-1000 μm and more preferably 50-500 μm.

Next, the concavo-convex structure for improving the light taking-out effect from the organic EL element and for diffracting and diffusing light will be described.

The concavo-convex structure for diffracting or diffusing light is provided in the substrate or on a total reflection surface of the substrate. For example, by providing the concavo-convex structures for diffracting or diffusing light on the surface of the outermost layer of the substrate, in the case where organic EL element layers comprising a transparent electrode (anode) and a light-emitting layer and a cathode are formed on the surface to make an organic EL element, of the light radiated from the light emitting layer, the portion of light that is usually subjected to total reflection at the interface and is not taken out, is now taken out and thus light emitting efficiency is improved.

More specifically, in the present invention, the concavo-convex structure for diffracting light is a structure which is provided on an total reflection interface and is formed of a concavo-convex structure which has a fixed pitch (cycle).

In order to improve the taking-out efficiency of visible light, the concavo-convex structure must be a diffraction grating for diffracting the visible light of wavelength in a medium in the range of 400 nm-750 nm. There is a fixed relationship between the input angle and output angle for light to the diffraction grating, the diffraction grating interval (the cycle for the concavity and convexity array), the light wavelength, the medium refractive index, the diffraction order and the like, and in order to diffract visible light and light of the wavelength region in the vicinity of visible light, in the present invention, the pitch (cycle) of the concavity and convexity array must have a fixed value in the range of 150 nm-3000 nm corresponding the wavelength whose taking-out efficiency is to be increased.

The concavo-convex structure to be used as the diffraction grating may be one described in Unexamined Japanese Patent Application No. H11-283751 and Unexamined Japanese Patent Application No. 2003-115377. The striped diffraction grating does not have a diffraction effect in the direction parallel to the stripes, and thus a diffraction grating that acts uniformly as a diffraction grating from any direction in two dimensions is preferable. It is also preferable that the cross-sectional configuration viewed from the normal line direction of the substrate surface or the display surface is one in which the concave portions and convex portions of a predetermined figure are formed on a plane with regular fixed intervals.

The configuration of the concavities and convexities may be such that the shape of the hole forming the concave portion may be triangular, rectangular or polygonal. The internal diameter of the hole (given that the holes have the same surface area) is preferably in the range of 75 nm-1500 nm. In addition, the cross-sectional configuration of the concave portion (void) when viewed from the planar direction may be semicircular, rectangular of pyramid-shaped. The depth of the concave portion is preferably in the range 50 nm-1600 nm and more preferably in the range 50 nm-1200 nm. If the depth of the concave portion is smaller than this, the effect of causing diffraction and diffusion is small, while if it is too large, the smoothness as a display element is lost, and thus this is unfavorable. In addition, in order to function as a diffraction grating, the arrangement of the concave portions preferably one in which a two-dimensional regular arrangement, such as a rectangular lattice (rectangular grid) or a honeycomb lattice, is repeated.

In addition, in the case of a protrusion (projection), the shape of the protrusion may be the same as above, and for example in the case where the protrusion has a cylindrical shape, the form viewed from the normal line direction may be circular, triangular, rectangular or polygonal. The height of the protrusion or the pitch (cycle) thereof is the same as that for forming the aforementioned recesses. The convex portion is formed to have a value such that concavo-convex portions are exact opposites.

An example of the concavo-convex structure which acts as a diffraction grating formed in this manner is shown in FIG. 2. It illustrates the example where the circular and rectangular concave portions (holes) are formed on the substrate surface.

By forming this type of concavo-convex structure on the substrate surface, forming a transparent electrode on the substrate, forming organic EL element layers sequentially, forming counter electrodes and forming organic EL elements, light emitted from the substrate side is taken-out. This arrangement improves the taking-out effect of the light of the wavelength corresponding to the pitch (cycle) of the concavo-convex structure.

In the case where these diffraction grids are to be formed on the resin substrate film, there is available an imprint method and the like, and the imprint method may be used in which the polymer film is formed of a thermoplastic resin such as polymethylmethacrylate (called PMMA hereinafter), and then by applying heat and pressure using a mold provided with concavities and convexities, the concavo-convex configuration of the mold can be transferred. Also, a method can be used in which, after coating a UV light photocurable resin, the cast that has concavities and convexities is brought into close contact and UV light is irradiated, and curing is performed by photopolymerization, and the concavities and convexities of the mold are transferred.

In the case where a metal oxide such as silicon oxide and the like which is the gas barrier layer is etched to make the concavo-convex configuration, reactive ion etching and the like can be used.

For a film of a metal oxide such as silicon oxide and the like which is the gas barrier layer, the sol-gel method may be used to form a gel-like film and then the concavo-convex configuration can be formed by pressing the mold that has concavities and convexities in the gel-like film and then heating it as it is.

In the concavo-convex structure for diffusing light of the present invention is a structure such as a wave form for diffusing light by light diffraction, refraction and reflection, and for example, the average pitch (cycle) is in the range 0.3 μm-20 μm, the average height is in the range of 100 nm-7000 nm which is about ⅕-⅓ of the pitch. By diffusing the light which is reflected by total reflection or by the metal electrode as the cathode electrode and transmits inside the light emitting layer, in order to take out sufficient amount light compared with the amount of light directly irradiated out of the device, the height of the concavities and convexities is preferably at least 100 nm. Also, if the pitch (cycle) of the waveform is too long, light is absorbed by the light emitting layer before the scattering phenomenon occurs. Furthermore, if the average height is too large, formation of the light emitting layer is difficult, and thus this is not preferable.

In the case where these types of dispersion structures are to be formed on the resin substrate film, there is an imprint method and the like, and the imprint method may be used in which a thermoplastic resin such as PMMA is used to form the polymer film, and then by applying heat and pressure using a mold that has a waveform, the waveform of the mold can be transferred. Also, a method can be used in which, after coating a UV light photocurable resin, the cast that has the waveform is brought into close contact and UV light is irradiated, and curing is performed by photopolymerization and the waveform of the mold is transferred.

In the case where the metal oxide such as silicon oxide and the like which is the gas barrier layer is etched to make the concavo-convex structure, reactive ion etching can be used. In addition, the sol-gel method may be used for the film formed of a metal oxide such as silicon oxide and the like which is the gas barrier layer to form a gel-like film, and then the waveform configuration can be formed by pressing the mold that has waveform configuration in the gel-like film, and then heating it as it is.

Next, the layer (diffusion layer) for diffracting or diffusing light in the present invention will be described.

The layer for diffracting or diffusing light is another structure for improving the light taking-out efficiency, and in the case where this is formed on the outermost layer, or in other words, the layer which contacts the organic EL elements, there are contained, in the layer, spherical particles of a refractive index which is different to a certain extent from the resin material (binder) for example, and the refraction index difference is 0.03 or more, and more preferably 0.1 or more.

Because this is the layer which diffuses light due to the difference in refractive index of the layer medium and the particles, the particle diameter of the particles included is preferably larger (average particle diameter 300 nm-30 μm) than the light wavelength and the particles are preferably transparent.

Thus examples of these types of particles include inorganic material such as glass, silica and titanium and organic material such as acrylic resins, polyester resins and epoxy resins.

The specific volume of the particles with respect to the medium which forms the layer which is a resin material for example is preferably 10-90%. If this range is exceeded, sufficient light dispersion function cannot be obtained. In addition, the thickness of these layers is preferably in the range 300 nm-50 μm.

Thus, in order to form these layers, in the case where the layer medium is a resin material for example, the particles are dispersed in a resin material (polymer) solution which will be the medium and then coated on a coating substrate. Note that any solvent which does not dissolve the particles can be used for the solution.

Because these particles are actually polydispersed particles and are difficult to arrange regularly, the layer is one in which light taking-out efficiency is improved by mainly changing the light direction, although there is locally a diffraction effect.

In addition, as is the case in the following embodiment, the layer medium preferably has a low refractive index. For example, a fluorine resin is preferably used as the medium.

The fluorine resin is preferably a hard fluorine resin, and examples are silane compounds including a perfluoroalkyl group (such as (heptadecafluoro 1,1,2,2-tetradecyl)triethoxy silane) and the like, as well as copolymers including fluorine which have as component monomers, monomers including fluorine and monomers for donating a cross-linking group.

Specific examples of the monomer unit containing fluorine include fluoroolefins (such as fluoroethylene, vinylidene fluoride, tetrafluoroethylene, hexafluoroethylene, hexafluoropropylene, perfluoro-2,2-dimethyl-1,3-dioxole and the like), (meta)acrylic acid portions or complete fluorine alkyl ester derivatives (such as biscoat 6FM (trade name, manufactured by Osaka Organic Chemicals) or M-2020 (trade name, manufactured by Daikin), and complete or partial fluorine vinyl ethers, and of these, hexafluoropropylene is particularly preferable in view of its low refractive index and easy monomer absorption.

Examples of the monomer for donating a cross-linking group include (meta)acrylate monomer including a cross-linking functional group in its molecule beforehand, as well as a (meta)acrylate monomer including a carboxyl group, hydroxyl group, amino group, or sulfonate group (such as meta (acrylic acid), methylol (meta)acrylate, hydroxy alkyl (meta)acrylate, aryl acrylate and the like). It is preferable that cross-linking structure is introduced after the latter is subjected to copolymerization.

In addition, not only the polymer having a monomer including fluorine as a structural unit may be used, but olefins, ester acrylates and monomers not including fluorine atoms may be used.

These hardening fluorine resins are used for cross-linking due to photocuring or by radiation of light (preferably ultraviolet light, electron beams or the like).

An example of the cross-linking fluorine resin used is JN-7228 (trade name) which is manufactured by JSR.

In addition, in order to achieve a low refractive index, there is a method in which hollow resin particles are mixed with the medium, and on average, the refractive index of the medium is reduced.

These hollow resin particles refer to particles that have particle walls and have a void inside, and examples include particles formed by coating the surface of organic silicon compound particles (alkoxysilanes such as tetraethoxy silane) which have microvoids inside the particle, and closing the small hole entrance. Alternatively, the void inside the particle wall may be filled with solvent or air, and in the case where it is filled with air, the refractive index of the hollow particles can be made considerably low (refractive index=1.44-1.25) compared to normal silica (refractive index=1.46). The preparation method for making the particles having the microvoids inside the inorganic particles hollow may be the methods described in the Unexamined Japanese Patent Application Publication No. 2001-167637, 2001-233611, and in the present invention, commercially available hollow SiO₂ particles may be used. A specific example of the commercially available particles is P-4 and the like manufactured by Catalysts and Chemicals Industry Co., Ltd.

The present invention is one in which the barrier layer and the concavo-convex structure which diffracts or diffuses light on a resin film substrate, or alternative layers which diffract or diffuse light are laminated or combined on a resin film substrate, and thus an organic EL resin film substrate is obtained in which the gas barrier properties are high, and when the organic EL element is formed, the light taking-out efficiency from the light emitting layer is high. These resin film substrates may be used as the light taking-out side substrate, and a transparent electrode which will be the anode, organic EL element layers (described hereinafter) and a metal electrode which is a cathode are sequentially laminated on the resin film substrate, and there is obtained the organic EL device of the present invention which is sealed from gases which cause deterioration of the organic EL element due to external gases, particularly water vapor and oxygen. If after the organic EL element is formed, one more gas barrier layer film is placed on the cathode, and at least the peripheral area is brought in close contact and sealed, the organic EL element can be further separated and protected from gases which cause deterioration of the organic EL element due to external gases, particularly water vapor and oxygen.

A few embodiments of the organic EL resin film substrate of the present invention which include the gas barrier layer are described in the following.

FIG. 3 shows one embodiment of the invention. FIG. 3 shows a structure in which a stress relief layer 4, a gas barrier layer 3 and a stress relief layers 4 are laminated on the film substrate 1, and a diffracting structure is provided on the surface of the stress relief layer that is on the gas barrier layer, or in other words, on the outermost surface of the resin film substrate.

On the outermost surface of the gas barrier layer is provided a concavo-convex structure which diffracts or diffuses light, and by forming an ITO/organic EL layer/electrode thereon, the light which was not taken out to the outside because of the total reflection at one of the interfaces of the substrate, the gas barrier, the ITO and the organic EL layer can be taken out to the outside.

The film substrate is one in which a PES (polyether sulfon) film (thickness 200 μm) out of the resin films, for example, is used, and first a PMMA is formed as a stress relief layer or an adhesive layer is formed on the resin film. The PMMA film is one which is formed according to a method described in WO00/36665 pamphlets, by introducing a polymethyl metacrylate oligomer from a introduction nozzle into a vacuum deposition device, and then depositing it on the PES film substrate, and after taking the PMMA deposition film out from the vacuum deposition device, ultraviolet light is irradiated in a dry nitrogen flow, and polymerization occurs, and a PMMA polymerized film (film thickness 200 nm for example) is formed.

On this film, a silicon oxide film (film thickness of 200 nm for example) is formed by the atmospheric pressure plasma CVD method using film formation gas with tetraethoxysilane as the main component and nitrogen as the discharge gas.

Next, there is formed a resin layer which also functions as the stress relief and is provided with the concavities and convexities arranged thereon in a rectangular grid. The resin layer is formed by the foregoing method as a PMMA film having a thickness of 400 nm, and imprint molding is performed on the surface to form the concavo-convex structure.

That is to say, imprint molding is performed by applying heat and pressure by a stainless steel roller that has pre-formed embossing. The concavities and convexities have a diameter of 150 nm and depth of 120 nm and form a rectangular lattice with a pitch on 300 nm. Due to the diffraction effect, the light taking-out efficiency for the 530-580 nm region which is the so-called green region is increased.

The concavities and convexities may be formed by embossing UV cured resin.

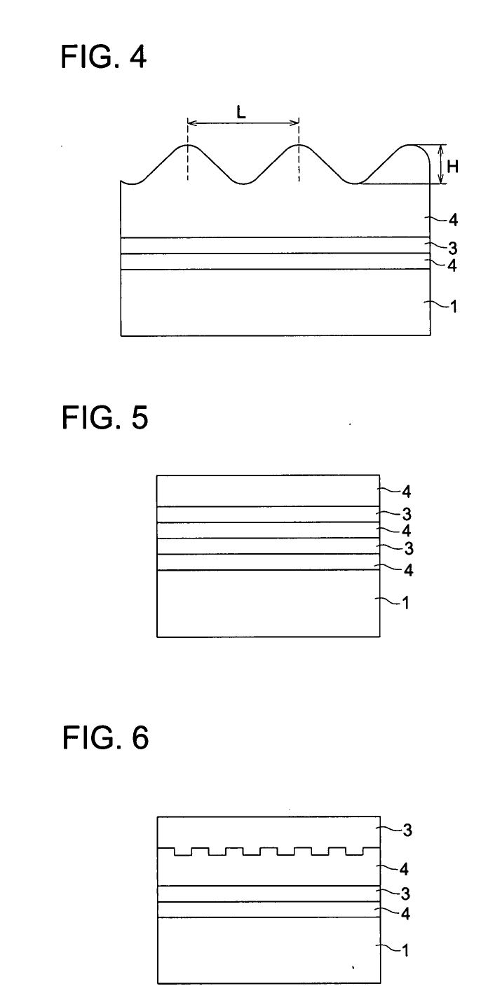

In addition, the surface which is an example of the diffusion structure for diffusing light is shown in FIG. 4. In FIG. 4, 1 is the substrate film, 3 is the gas barrier layer and 4 is the stress relief layer. In order to form the diffusion structure, molding is done using an imprint method such that the PMMA resin is formed having, for example, the average pitch (pitch L) of 3 μm and the average height (height H) of 500 nm, after forming it with a thickness of a few μm.

In addition, the surface which diffracts or diffuses light may be formed directly on the gas barrier layer surface without forming the stress relief layer on the outermost layer (not shown). In the case where regular diffraction structures are formed, the surface of the gas barrier layer (such as silicon oxide layer) is subjected to patterning processing by reactive ion etching (RIE), namely reactive ion etching with a gas mixture of CF₄ and H₂ as the reaction gas and using Microposit 1400-27 (trade name) manufactured by Shiprei for example is used as the photoresist.

In addition, by selecting the conditions and performing reactive ion etching (RIE) without using resist, a diffusion structure which has a diffusion surface of a large cycle can be formed on the surface.

In addition, after the gel-like film is formed using the sol-gel method, the film may be pressed in the mold and heated and molded.

By forming a transparent electrode which is the anode, organic EL element layers, and a cathode on the surface which has this diffracting structure or diffusing structure, the organic EL device of the present invention is obtained.

Next, the second embodiment of the present invention is shown in FIG. 5.

This is an example of the resin film substrate which comprises a gas barrier layer which has a layer (diffusion layer) which diffracts or diffuses light which is also a stress relief layer on the outermost layer.

In the same manner as the first embodiment, the stress relief layer 4, as also an adhesive layer, is provided on a PES (thickness 200 μm) as a resin film substrate 1. That is to say, a vacuum deposition device is used and polymethyl methacrylate oligomer is introduced and deposited, and ultraviolet light is introduced in the same manner and polymerization is done to form a PMMA polymer film (thickness 200 μm). Next, in the same manner, on this film, a silicon oxide film is formed with a thickness of 200 μm by the plasma CVD method, and these are repeated and in the same manner, the PMMA layer (200 nm) which is the stress relief layer 4 as well as the gas barrier layer (silicon oxide layer) 3 which is 200 nm thick for example, is provided on the silicon oxide film.

In this embodiment, as a outermost layer, a diffusion layer (layer which diffracts or diffuses light) 5 which is also a stress relief layer is provided. Because this diffusion layer diffracts or diffuses light, by forming an organic EL element comprising ITO/organic EL layers/electrodes on the layer, the light which was not taken out due to the total reflection between the interface of one of the substrate, the gas barrier layer, the ITO and the organic EL layer gets to be taken out by being diffracted and diffused.

The outermost layer which diffracts or diffuses light is a layer in which transparent particles which diffuse light such as TiO₂ are dispersed, and a fluorine resin such as a cross-linking fluorine resin (6% methyl ethyl ketone solvent; Trade name JN-7228, manufactured by JSR) is used as the solvent and synthetic titanium oxide particles (average particle diameter 2.1 μm, refractive index 2.5) are included in the resultant solution such that the solid content concentration is 10%, and after coating, drying was done at 120° C. and then ultraviolet rays were irradiated, and thermal curing was further performed at 120° C., and a layer which diffracts or diffuses light was thereby formed (thickness 800 nm-5 μm).

Next the third embodiment of the present invention will be described.

In the first and second embodiment (FIGS. 3, 4 and 5), the layer having the concavo-convex structure for diffracting light provided on the outermost surface and the outermost layer (dispersion layer) which diffracts or diffuses light preferably have a refractive index which is as low as possible, and are also preferably (sufficiently) thicker (0.3 pm or more preferably 1 micron or more) than the wavelength. As a result, a portion of the light that will be totally reflected at the inside of the substrate can be taken out to the outside, and a substrate can be obtained in which the taking-out efficiency is further improved.

That is to say, the light that is totally reflected at the interface between the substrate and the outermost layer is reduced to an amount that is determined by the critical angle of the low refractive index layer. Thus the refractive index is preferably low and is preferably 1.50 or lower. The refractive index is preferably low, but there are limitations on the low refractive index material, and thus fluorine resins are used, and the refractive index of the layer can be reduced by including particles having voids such as hollow silica gel particles.

In this third embodiment, hollow silica particles (P-4 manufactured by Catalysts and Chemicals Industry Co., Ltd.) are added to the fluorine resin which is the medium comprising a layer for diffracting or diffusing light in the second embodiment to form the layer. By mixing the hollow resin particles by the same amount, in solid, of the fluorine resin, the refractive index of the medium becomes about 1.37.

In addition, a gas barrier layer formed of silicon oxide and the like has comparatively high density and refractive index, and thus, in the case where the stress relief layers which have stress relief functions and the like are laminated to form a multi-layer film, when the organic EL element is formed, the outermost layer of the substrate which contacts the transparent electrode (ITO) is a layer which has a high refractive index and gas barrier function, and thus it becomes possible to take out a portion of the waveguide mode light (light that is trapped in the ITO and organic EL layer) to the gas barrier layer. Also as a result, the diffraction or the diffusion function for light taking-out can be provided in the adjacent stress relief layer for which it is comparatively easy to impart diffracting or diffusing function. When this is done, providing the diffracting or diffusing function in the lower layer which is not the outermost surface facilitates the smoothness of the outermost surface to increase, and formation of the light emitting layer becomes easy.

Next, the fourth embodiment shown in FIG. 6 which is expected to have the above effects will be shown. In FIG. 6, after the stress relief layer 4 and the gas barrier layer (each 200 nm thick) are provided on the resin film substrate, another stress relief layer 4 is provided and a diffracting structure is provided on the surface thereof. A gas barrier layer 3 is further provided thereon, and by forming the gas barrier layer 3 that is formed at the outermost surface of a material with a high refractive index of 1.45 or more and 2.10 or less, it becomes easy to take out a portion of the waveguide mode light (light that is trapped in the ITO and organic EL layer) to the high refractive index layer. In addition, by providing concavities and convexities which diffract or diffuse light at the interface with the adjacent stress relief layer immediately below, it can be expected that the light that is taken out to the high refractive index layer will be effectively taken out to the outside, and the light that is totally reflected at the interface of the substrate and the gas barrier layer will be effectively taken out.

In order to form the diffracting structure, as described above, a surface on which holes having a pitch (cycle) of 300 nm, diameter of 150 nm and depth of 120 nm are arranged in a rectangular grid on the stress relief layer which comprises PMMA is formed by the foregoing method.

In the fourth embodiment, a SiN (silicon nitride) layer, as the outermost gas barrier layer, with a thickness of, for example, 200 nm, is formed thereon by the plasma CVD method. After the formation, the surface projections and the like are removed using polishing tape (Number 15000) manufactured by MIPOX, and the film is thereby made smooth.

This type of substrate preferably has a silicon nitride layer which has a high refractive index of 1.8 as the gas barrier layer on the surface.

The substrate, the stress relief layer and the gas barrier layer herein are the same as those in FIG. 1 and FIG. 2. The diffracting structure and the diffusing structure are also formed in the same manner.

In order to form the diffusing structure, in the same manner above, a surface which has random waveform such that the average pitch is 3 μm, and the average height is 500 nm is formed on the stress relief layer comprising PMMA in replacement of the diffracting structure.

The fifth aspect is one in which a layer (diffusion layer) a layer which diffracts or diffuses light replaces a stress relief layer which has the structure for causing diffraction of light on the surface in FIG. 6. As described above, there is used a layer formed of s fluorine resin with transparent TiO₂ and the like dispersed therein which diffuses light, and the light taking-out is facilitated by diffusion of light. The resin layer, for example, which is the layer medium, preferably has a low refractive index, is preferably a fluorine resin, and preferably includes hollow particles such as silica and the like inside.

The sixth aspect of the present invention has a gas barrier layer as the outermost layer as the same case as in the embodiments 4 and 5, and the diffracting structure which is provided on the surface of the stress relief layer immediately below the outermost layer or the layer (dispersion layer) which diffracts or diffuses light and is also the stress relief layer immediately below the outermost surface is formed a layer having a refractive index which is as low as possible.

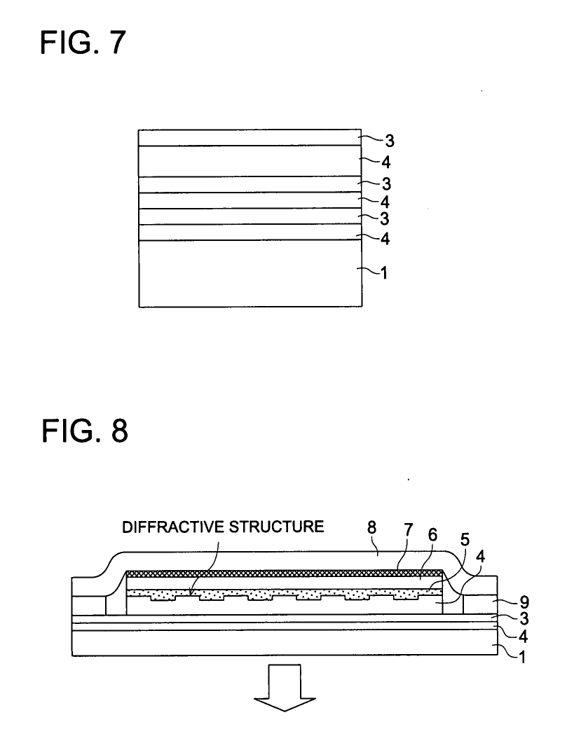

Of these, the embodiment in which the layer (diffusion layer) which diffracts or diffuses light is provided directly below the outermost gas barrier layer that is also the stress relief layer is shown in FIG. 7. Because the light diffusing layer is formed of a material that has a sufficiently low refractive index, namely 1.50 or less and 1.03 or more, and the layer has a thickness that is sufficiently longer than the wavelength (greater than 0.3 μm and preferable greater than 1 μm), in the same manner as the foregoing, it becomes possible to take out a portion of the light to have been totally reflected at the inside of the substrate, to the outside. (The light that is subjected to total reflection at the inside of the substrate is reduced to an amount that is determined by the critical angle of the low refractive index layer.)

In this embodiment, the outermost gas barrier layer 3 is the layer formed from SiN (thickness 100 nm) and the adjacent stress relief layer 4 which is directly below the gas barrier layer 3 is one in which synthetic titanium oxide particles (average particle diameter 2.1 μm, refractive index 2.5) are incorporated in a cross-linking fluorine resin (6% MEK solvent; Trade name JN-7228, manufactured by JSR) such that the solid content concentration is 10%, and after coating, drying was done at 120° C., and then ultraviolet rays were irradiated and thermal curing was further performed at 120° C., and layer (dispersion layer) which diffracts or diffuses light is thereby formed (thickness 800 nm-a few μm). In addition, because hollow silica particles (P-4 manufactured by Catalysts and Chemicals Industry Co., Ltd.) are mixed with about the same amount of the fluorine resin, and the refractive index of the medium becomes about 1.37.

The refractive index is preferably as low as possible, and when the fluorine resin is used together with the hollow particles, it is about 1.25.

By using this type of organic EL resin film substrate, an organic EL device is obtained in which gas barrier properties are excellent and light taking-out efficiency is improved.

Next, the organic EL element for forming these organic EL resin film substrates and the organic EL device of the present invention will be described.

The organic EL element of the present invention will be described in the following.

<<Layer Composition of the Organic EL Element>>

The following are specific examples of the preferable layer compositions of the organic EL element in the present invention, but the present invention is not to be limited by these examples. (i) anode/light emitting layer/electron transport layer/cathode (ii) anode/hole transport layer/light emitting layer/electron transport layer/cathode (iii) anode/hole transport layer/light emitting layer/positive hole blocking layer/electron transport layer/cathode (iv) anode/hole transport layer/light emitting layer/hole blocking layer/electron transport layer/cathode buffer layer/cathode (v) anode/anode buffer layer/hole transport layer/light emitting layer/hole blocking layer/electron transport layer/cathode buffer layer/cathode

<<Anode>>

The anode in the organic El element is preferably a conductive substance such as a metal, alloy or electrically conductive compound with a large work function (4 eV or more) or a mixture of these substances. Specific examples of these electrode materials include metals such as Au, conductive transparent material such as CuI, indium tin oxide (ITO), SnO₂, ZnO and the like. In addition, amorphous materials such as IDIXO (IN₂O₃—ZnO) and the like may be used for preparing the transparent conductive film. The anode is formed by forming a thin film using these electrode materials by deposition or sputtering, and a pattern of a prescribed configuration is formed by photolithography. In the case where emitted light is taken out through the anode, it is preferable that the permeation rate is larger than 10%, and the sheet resistance of the anode is preferably a few hundred Q/square. Furthermore, the film thickness depends on the material, but it is usually selected to be in the range 10-1000 nm and more preferably to be in the range of 10-200 nm. Materials such as indium tin oxide (ITO), SnO₂, ZnO and the like are preferable as the light taking-out side electrode.

<<Cathode>>

The cathode is a conductive substance such as a metal (called electron injection type metal), alloy or electrically conductive compound with a small work function (4 eV or less) or a mixture of these substances. Specific examples of the electrode material include sodium, sodium potassium alloy, magnesium, lithium, aluminum, magnesium/silver mixtures, magnesium/aluminum mixture, aluminum/aluminum oxide (Al₂O₃) mixture, lithium/aluminum mixture and rare earth metals and the like. Of these, electron injected metals and stable metals whose work function values are larger than that of the electron injected metals are favorable in view of resistance to electron injection and oxidation. These include mixtures with second metals such as magnesium/silver mixture, magnesium/aluminum mixture, aluminum/aluminum oxide (Al₂O₃) mixture, lithium/aluminum mixture and aluminum and the like. A thin film is formed using these electrode materials by deposition or sputtering. The sheet resistance of the cathode is preferably a few hundred Q/square or less and the film thickness is normally selected in the range of 10 nm-1000 nm, and more preferably 50 nm-200 nm. It is to be noted that because the emitted light goes through the electrode, if one of the anode or the cathode of the organic EL element is transparent or semi-transparent, emitted light brightness will be improved and thus this is preferable.

Next the light emitting layer, the injection layer, the hole transport layer, and the electron transport layer of the organic EL element of the present invention will be described.

<<Injection Layer>>: Electron Injection Layer and Positive Hole Injection Layer

The injection layer is provided if necessary, and examples are an electron injection layer and a hole injection layer, and as described above they may be provided between the anode and the light emitting layer or the hole transport layer, or between the cathode and the light-emitting layer or the electron transport layer.

The injection layer is a layer provided between the electrode and the organic layer in order to reduce drive voltage and improve brightness of emitted light, and examples include the hole injection layer (anode buffer layer) and the electron injection layer (cathode buffer layer) described in detail in Chapter 2 “Electronic Material” (pages 123-166) of the second edition of “Organic EL Elements and their Industrial Frontier” (Published Nov. 30, 1998 by N.T.S).

The anode buffer layer (hole injection layer) is also described in detail in Unexamined Japanese Patent Application Publication No. H9-45479, No. H9-260062, and No. H8-288069, and specific examples include phthalocyanine buffer layers as represented by copper phthalocyanine, oxide buffer layers represented by vanadium oxide, amorphous carbon buffer layers, polyaniline (emeraldine) and polymer buffer layers using conductive polymers such as polythiophene.

The cathode buffer layer (electron injection layer) is described in detail in Unexamined Japanese Patent Application Publication No. H6-325871, No. H9-17574, and No. H10-74586, and specific examples include metal buffer layers represented by those of strontium and aluminum, alkali metal compound buffer layers as represented by those of fluorinated lithium, alkali earth compound buffer layers as represented by fluorinated magnesium, and oxide buffer layer as represented by those of aluminum oxide.

The buffer layer (injection layer) is preferably a thin film, and although the thickness depends on the material, it is preferably in the range of 0.1 nm-100 nm.

As is the case above, the blocking layer is provided if necessary, in addition to the elemental component layers of the organic compound thin film. Examples include the hole blocking layer described in Unexamined Japanese Patent Application Publication No. H11-204258, No. H11-204359, and on page 27 of “Organic EL Elements and their Industrial Frontier” (Published Nov. 30, 1998 by N.T.S).

As described above, using a wide definition, the hole blocking layer is an electron transport layer, and it is formed of a material which has electron transport function and in which the positive hole transport capability is remarkably low, and the recombination probability for electrons and holes is improved by transporting electrons and blocking the positive holes.

Meanwhile, using a wide definition, the electron blocking layer is a hole transport material and it is formed of a material which has positive hole transport function and in which the electron transport capability is remarkably low, and the recombination probability for electrons and holes is improved by transporting holes and blocking electrons.

The hole transport layer is formed of a material having a hole transport function, and using a wide definition, the hole transport layer includes hole injection layer and electron blocking layer.

The injection layer can be formed by making a thin layer using a known method such as the spin coating method, the casting method, the inkjet method, and the LB method and the like. No particular limitations are imposed on the thickness of the injection layer, but it is usually about 5-5000 nm. The injection layer may have a single layer construction formed of one or more of the above materials.

In the case where the deposition method is used for film formation, the deposition conditions should be varied depending on the type of compounds used, but generally the ranges for the conditions are suitably selected such that the boat heating temperature is 50-450° C., the degree of vacuum is 10⁻⁶ Pa-10⁻² Pa, the vapor deposition rate is 0.01 nm-50 nm/second, the substrate temperature is −50° C.-300° C., and the film thickness is 0.1 nm-5 μm.

<<Light Emitting Layer>>

In the present invention, no particular limitation is imposed on the type of light emitting material used in the light emitting layer, and known light emitting materials in conventional organic EL elements may be used. These light emitting materials are mainly organic substances, and examples include the compounds described in pages 17-26 of Macromol. Symp. Volume 125.

In addition to the light emitting function, the light emitting layer may also have positive hole injection function and electron injection function, and in most cases, the positive hole injection and the electron injection material can be used as light emitting material.

The light emitting material may be a polymer material such as p-polyphenylene vinylene or polyfluorene and also polymer material in which the light emitting material is introduced into the polymer chain, or in which the light emitting material is introduced into the polymer main chain may be used.

Also, in addition to the light emitting host substance, a dopant (guest substance) may also be included in the light emitting layer, and this may be suitably selected from known substances used as a dopant for an organic EL element.

(Light Emitting Host and Light Emitting Dopant)

The mixing proportions of the light emitting dopant with respect to the host compound which is the main component of the light emitting layer is preferably in the range between 0.1% by mass and 30% by mass.

The light emitting dopant can be largely divided into two types which are fluorescent dopant which emits fluorescent light and phosphorescent dopant which emits phosphorescent light.

Typical examples of the fluorescent dopant include organic dyes such as coumarin dyes, pilan dyes, cyanine dyes and the like as well as rare earth fluorescent complexes.

Typical examples of the phosphorescent dopants preferably are complex compounds including metals in groups 8, 9 and 10 of the periodic table, and more preferably indium compounds and osmium compounds, and indium compounds are most preferable of all.

In the present invention, in addition to the light emitting host, a phosphorescent compound (phosphorescent dopant) is preferably used in at least one light emitting layer.

Other specific examples of the phosphorescent dopant are those chemicals described in the following patent publications.

International Patent Publication No. 00/70655 Pamphlet, Unexamined Japanese Patent Application Publication No. 2002-280178, Unexamined Japanese Patent Application Publication No. 2001-181616, Unexamined Japanese Patent Application Publication No. 2002-280179, Unexamined Japanese Patent Application Publication No. 2001-181617, Unexamined Japanese Patent Application Publication No. 2002-280180, Unexamined Japanese Patent Application Publication No. 2001-247859, Unexamined Japanese Patent Application Publication No. 2002-299060, Unexamined Japanese Patent Application Publication No. 2001-313178, Unexamined Japanese Patent Application Publication No. 2002-302671, Unexamined Japanese Patent Application Publication No. 2001-345183, Unexamined Japanese Patent Application Publication No. 2002-324679, International Patent Publication No. 02/15645 Pamphlet, Unexamined Japanese Patent Application Publication No. 2002-332291, Unexamined Japanese Patent Application Publication No. 2002-50484, Unexamined Japanese Patent Application Publication No. 2002-332292, Unexamined Japanese Patent Application Publication No. 2002-83684, Japanese National Publication No. 2002-540572, Unexamined Japanese Patent Application Publication No. 2002-117978, Unexamined Japanese Patent Application Publication No. 2002-338588, Unexamined Japanese Patent Application Publication No. 2002-170684, Unexamined Japanese Patent Application Publication No. 2002-352960, International Patent Publication No. 01/93642 Pamphlet, Unexamined Japanese Patent Application Publication No. 2002-50483, Unexamined Japanese Patent Application Publication No. 2002-100476, Unexamined Japanese Patent Application Publication No. 2002-173674, Unexamined Japanese Patent Application Publication No. 2002-359082, 2002-175884, Unexamined Japanese Patent Application Publication No. 2002-363552, Unexamined Japanese Patent Application Publication No. 2002-184582, Unexamined Japanese Patent Application Publication No. 2003-7469, Japanese National Publication No. 2002-525808, Unexamined Japanese Patent Application Publication No. 2003-7471, Japanese National Publication No. 2002-525833, Unexamined Japanese Patent Application Publication No. 2003-31366, Unexamined Japanese Patent Application Publication No. 2002-226495, Unexamined Japanese Patent Application Publication No. 2002-234894, Unexamined Japanese Patent Application Publication No. 2002-235076, Unexamined Japanese Patent Application Publication No. 2002-241751, Unexamined Japanese Patent Application Publication No. 2001-319779, Unexamined Japanese Patent Application Publication No. 2001-319780, Unexamined Japanese Patent Application Publication No. 2002-62824, Unexamined Japanese Application Publication No. 2002-10474, Unexamined Japanese Patent Application Publication No. 2002-203679, Unexamined Japanese Patent Application Publication No. 2002-343572, and Unexamined Japanese Patent Application Publication No. 2002-203678.

Parts of the specific examples are shown below.

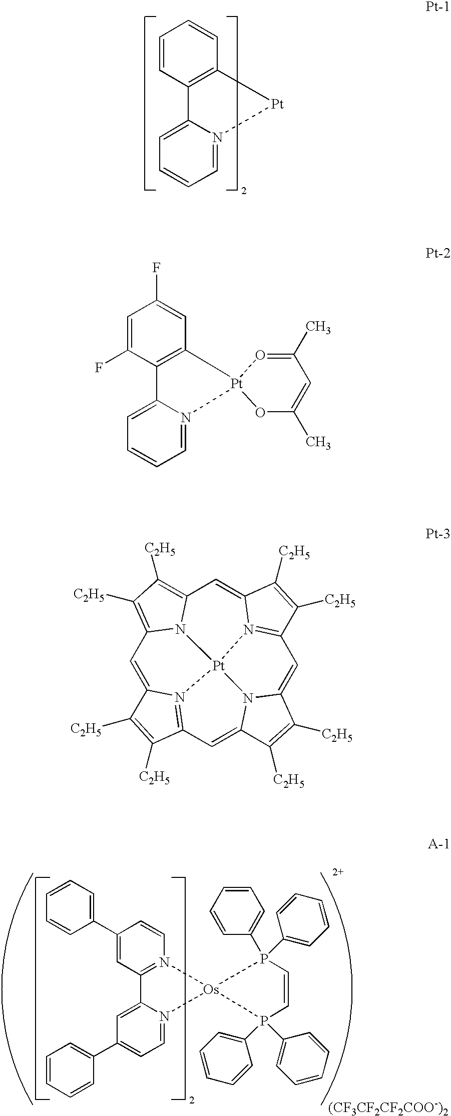

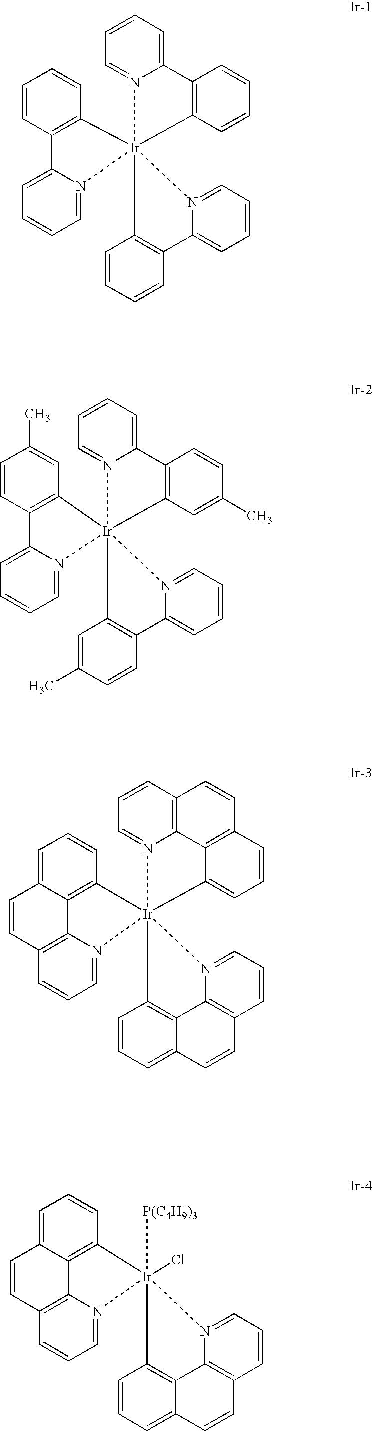

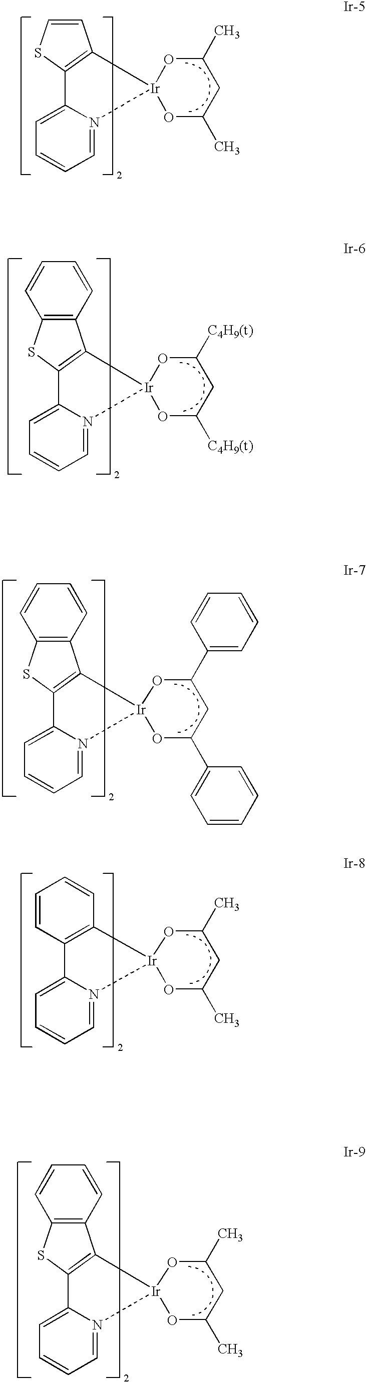

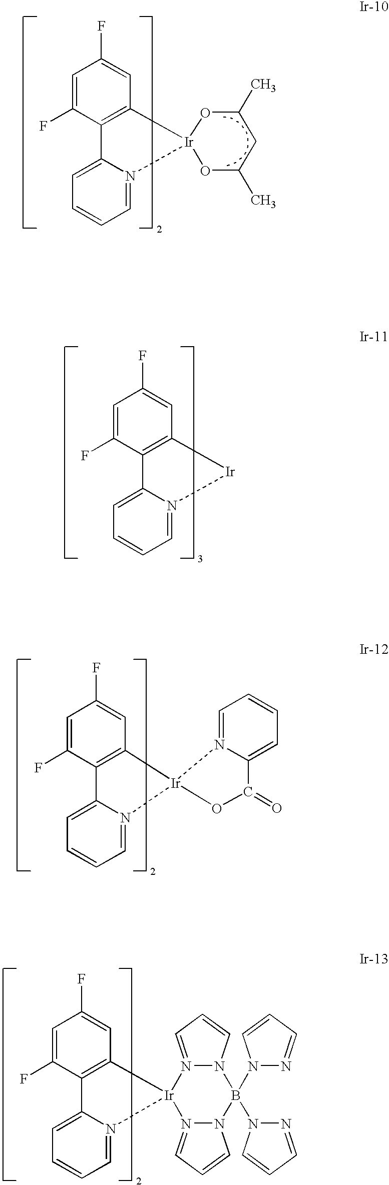

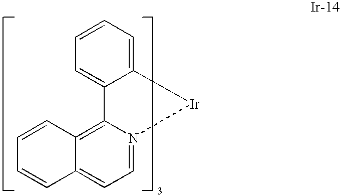

(Light Emitting Host Compound)

No particular structural limitations are imposed on the light emitting host compound used in the present invention, but typical examples include carbazole derivatives (CBP and the like are well known as carbazole derivatives), triaryl amine derivatives, aromatic borane derivatives (triaryl borane derivatives), nitrogen containing polycyclic compounds, thiophene derivatives, furan derivatives, basic skeletons containing oligoarylene compounds as well as carboline derivatives and diazacarbazole derivatives (The diazacarbazole derivative herein is one in which at least one hydrocarbon atom of the hydrocarbon ring comprising a carboline ring of a carboline derivative is substituted by a nitrogen atom.).

Of these materials, the carboline derivative, the diazacarbazole derivative and the like are preferably used.

The following are specific examples of the carboline derivative and the diazacarbazole derivative, but the present invention is not to be limited thereto.

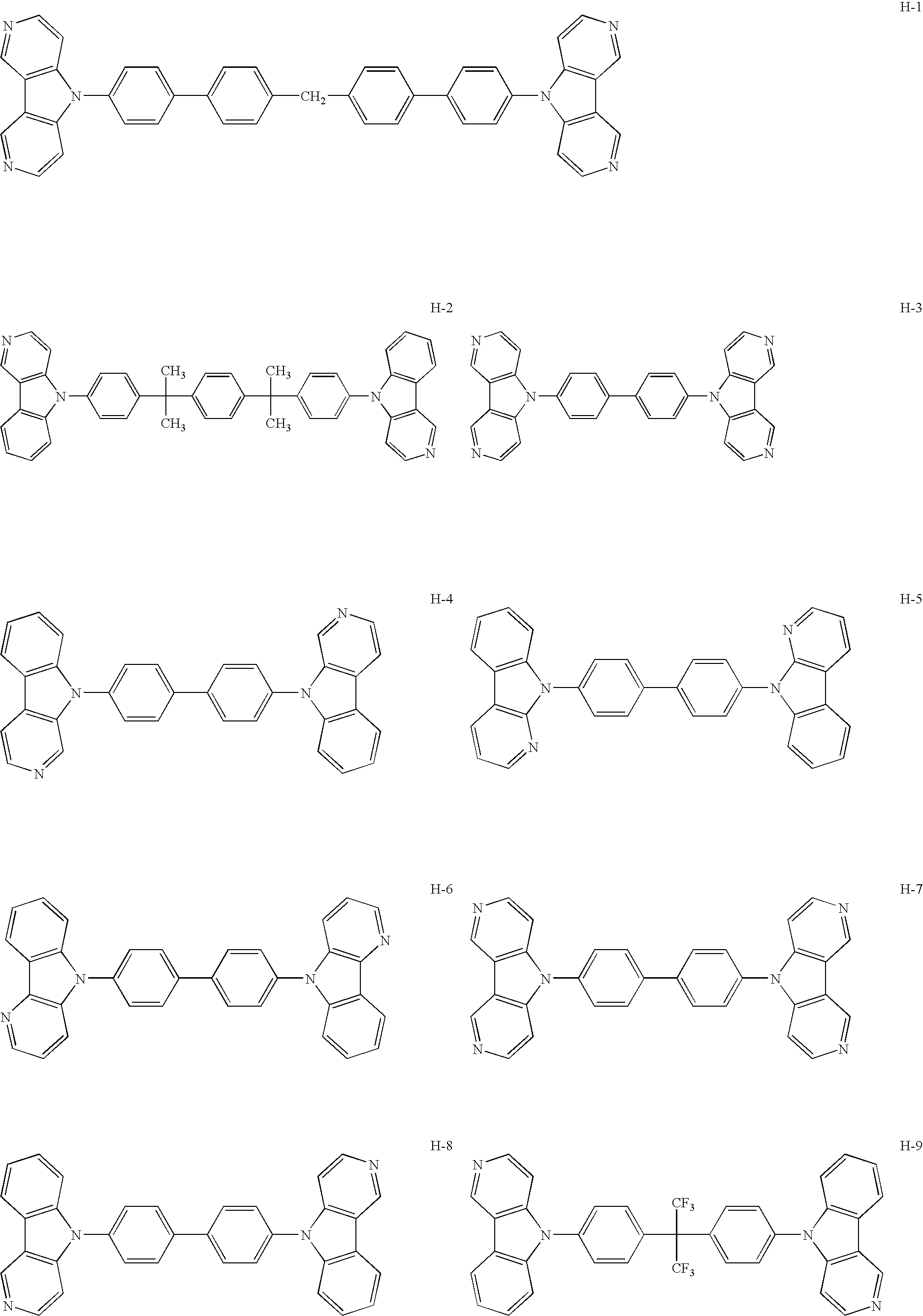

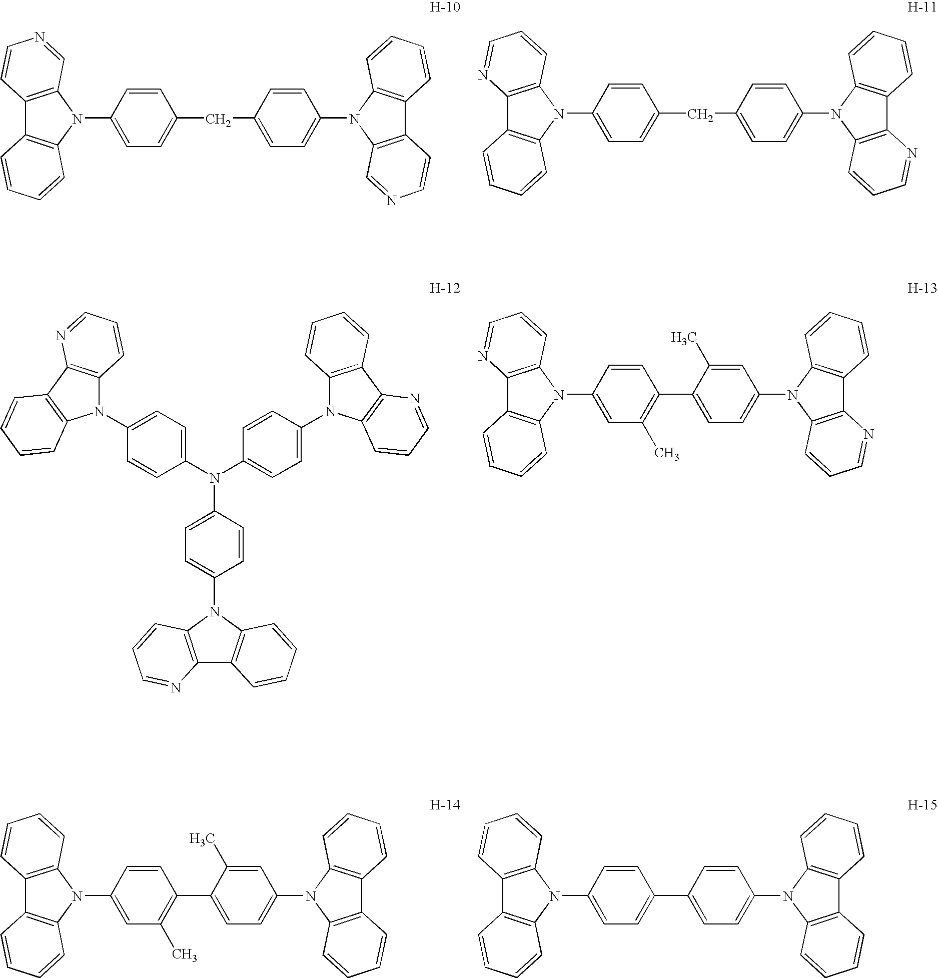

The light emitting host used in the present invention may be a low molecular weight compound or a high molecular weight compound having repeated units, or a low molecular weight compound including a polymerizable group such as a vinyl group or an epoxy group (deposited polymerizable light-emitting host).

The light-emitting host preferably has positive hole transport capabilities and electron transport capabilities and is preferably a compound which has a high Tg (glass transition temperature) and prevents from lengthening the wave length of emitted light.

In addition to those materials above, as specific examples of the light emitting host, the compounds described in the following documents are vavorable. Examples include Unexamined Japanese Patent Application Publication Nos. 2001-257076, 2002-308855, 2001-313179, 2002-319491, 2001-357977, 2002-334786, 2002-8860, 2002-334787, 2002-15871, 2002-334788, 2002-43056, 2002-334789, 2002-75645, 2002-338579, 2002-105445, 2002-343568, 2002-141173, 2002-352957, 2002-203683, 2002-363227, 2002-231453, 2003-3165, 2002-234888, 2003-27048, 2002-255934, 2002-260861, 2002-280183, 2002-299060, 2002-302516, 2002-305083, 2002-305084, and 2002-308837.

Another suitable example of a known light emitting host is the electron transport material and the positive hole transport material.

The light emitting layer can be formed by making a thin layer using a known film formation method such as the spin coating method, the casting method and the LB method and the like. No particular limitations are imposed on the thickness of the light emitting layer, but it is usually about 5 nm-5 μm. The light emitting layer may be a single layer structure formed of one or more of the above light-emitting materials, or a laminated structure formed of multiple layers which have the same or different composition.

<<Hole Transport Layer>>

The hole transport layer is formed of a material which has hole transport functions, and using a wide definition, it includes a hole injection layer, and an electron blocking layer. The hole transport layer may have a single layer or multiple layers.

No particular limitation is imposed on the hole transport material, and the material may be selected from those conventionally used as the charge injection and transfer material of hole in photoconductive materials, or from known materials used in the hole injection layer or the hole transport layer of the EL element.

The hole transport material is one which has hole injection or transport, or electron barrier properties and may be an organic or inorganic compound. Examples include triazole derivatives, oxadiazole derivatives, imidazole derivatives, polyaryl alkane derivatives, pyrazoline derivatives and pyrazolone derivatives, phenylene diamine derivatives, arylamine derivatives, amino substituted chalcone derivatives, oxazole derivatives, styryl anthracene derivatives, fluorolenone derivatives, hydrazone derivatives, stilbene derivatives, silazane derivatives, aniline copolymers and conductive high molecular weight oligomers, particularly thiophene oligomers.

The above materials can be used as the positive hole transport material, but porphyrin compounds, aromatic tertiary amine compounds and styryl amine compounds, and aromatic tertiary amine compounds in particular are preferably used.

Typical examples of the aromatic tertiary amine compound and the styryl amine compound are N,N,N′,N′-tetraphenyl-4-4′-diaminophenyl; N,N′-diphenyl-N,N′-bis(3-methylphenyl)-[1,1-phenyl]-4,4′-diamine(TPD); 2,2-bis(4-di-p-tolyl amino phenyl)propane; 1,1-bis(4-di-p-tolyl amino phenyl)cyclohexane; N,N,N′,N′-tetra-p-tolyl-4,4′-diaminobiphenyl; 1,1-bis(4-di-p-tolylaminophenyl)-4-phenyl cyclohexane; bis(4-dimethylamino-2-methylphenyl)phenyl methane; bis(4-di-p-tolylaminophenyl)phenyl methane; N,N′-diphenyl-N,N′-di(4-methoxyphenyl)-4,4′-diaminobiphenyl; N,N, N′,N-tetraphenyl-4,4′-diaminodiphenylether; 4,4′-bis(diphenylamino)quadriphenyl; N,N,N,-tri(p-tolyl) amine, 4-(di-p-tolylamino)-4′-[4-(di-p-tolylamino)styryl]stilbene; 4-N,N-diphenylamino-(2-diphenylvinyl)benzene; 3-methoxy-4′-N,N-diphenylamino styryl benzene; N-phenyl carbazole, as well as substances with two condensed aromatic rings in their molecules that are described in U.S. Pat. No. 5,061,569 such as 4,4′-bis[N-(1-napthyl)-N-phenylamino]biphenyl (NPD) or 4,4′,4″-tris[N-(3-methylphenyl)-N-phenylamino]triphenylamine (MTDATA) in which triphenylamine units are connected in starburst form, and which is described in Unexamined Japanese Patent Application Publication No. H4-308688.

Furthermore, polymer material in which these materials are introduced into the polymer chain or polymer material in which these materials are used as the polymer main chain may be used.

In addition, inorganic substances such as p-type Si, p-type SiC and the like may be used as the hole injection material and the hole transport material.

The hole transport material is preferably a compound with high Tg.

The hole transport layer can also be formed by making a thin layer using a known film method such as the vacuum deposition method, the spin coating method, the casting method, the inkjet method and the LB method and the like. No particular limitations are imposed on the thickness of the hole transport layer, but is usually about 5-5000 nm. The hole transport layer may be a single layer structure formed of one or more of the above materials.

<<Electron Transport Layer>>

The electron transport layer is formed of a material which has electron transport functions, and using a wide definition, the electron transport layer includes an electron injection layer and a hole blocking layer. The electron transport layer may be any layer having the function of transmitting electrons injected by the cathode to the light emitting layer and may have a single layer or multiple layers.

For example, platinum complexes may be used as the hole blocking material (electron transport). As a result, in the organic EL element that has the hole blocking layer as a component layer, it may be included and used as the hole blocking material or as the hole blocking material in the electron transport layer. In this case, the electron transport layer is also the hole blocking layer.

The electron transport material may also be suitably selected from compounds known heretofore.

In the case of the single layer and multiple layer electron transport layer, the following materials are known as the electron transfer material (which is also a hole blocking material) used in the electron transport layer adjacent to the cathode side with respect to the light emitting layer. Namely, nitro substituted fluorene derivative, diphenyl quinone derivatives, thiopyran dioxide derivatives, naphthalene perylene, polycyclic tetracarbonate anhydride such as naphthalene perylene and the like, carbodiimides, freolenidine methane derivatives, anthraquinodimethane, anthrone derivatives and oxadiazole derivatives. Furthermore, thiazole derivatives in which an oxygen atom in the oxadiazole ring is substituted with a sulfur atom and quinoxaline which has a quinoxaline ring which is known as an electron absorbing group are used as the electron transport material.

Furthermore, polymer material in which these materials are introduced into the polymer chain or polymer material in which these materials are used as the polymer main chain may be used.

Examples of metal complexes of 8-quinolinol derivative that may be used as the electron transport material include tris(8-quinolinol)aluminum (Alq), tris(5,7-dichloro-8-quinolinol)aluminum, tris(5,7-dibromo-8-quinolinol)aluminum, tris(2-methyl-8-quinolinol)aluminum, tris(5-methyl-8-quinolinol)aluminum, bis(8-quinolinol)zinc (Znq) and the like as well as metal complexes in which the main metal of these metal complexes is substituted by In, Mg, Cu, Ca, Sn, Ga or Pb. In addition, metal complexes in which metal free or metal phthalocyanine or the terminal ends of these complexes are substituted by an alkyl group or a sulfon group are preferably used as the electron transport material. In addition, the styryl pyrazine derivatives given as examples of the light emitting layer may also be used as the electron transport material and as is the case with the positive hole injection layer and the positive hole transport layer, inorganic semiconductors such as n-type Si, n-type SiC and the like may be used as the electron transport material.

In the case where compounds favorably used as the electron transport layer is applied to a blue or white light emitting element, display device and radiation device, the fluorescent maximum wavelength is preferably 450 nm or less and the 0-0 band of phosphorescent light is preferably 415 nm or less.

The compounds used in the electron transport material preferably have a high Tg.

The electron transport layer can be formed by making a thin layer using a known film method such as the vacuum deposition method, the spin coating method, the casting method, the inkjet method and the LB method and the like. No particular limitations are imposed on the thickness of the electron transport layer, but it is usually about 5-5000 nm. The electron transport layer may be a single layer structure formed of one or more of the above materials.

In the case where the deposition method is used for formation of the organic compound film, the deposition conditions should be varied depending on the type of compounds used, but generally the ranges for the conditions are suitably selected such that the boat heating temperature is 50-450° C., the degree of vacuum is 10⁻⁶ Pa-10⁻² Pa, the vapor deposition rate is 0.01 nm-50 nm/second, the substrate temperature is −50° C.-300° C., and the film thickness is 0.1 nm-5 μm.

After this layer is formed, a thin film formed of a cathode material is formed thereon, and the deposition method or the sputtering method for example is used such that the thickness of the film is less than 1 μm and more preferably in the range of 50 nm-200 nm, and a prescribed organic EL element is obtained by providing a cathode.

These organic material form the layer composition on the substrate, and the organic EL layer is thereby formed, but light emitting material emitting blue, green or red may be selected as the light emitting host and the dopant respectively for the light emitting material that is used in the light emitting layer, and the organic light emitting layer having light emissions in 3 colors are respectively thereby formed, and a full color display device can be formed using these as elements. In addition, in order to form the white light emitting element, white light emission may be obtained by using the organic EL elements to simultaneously emit light having a plurality of different colors and then mixing the colors. In order to obtain a plurality of different emitted light colors, a plurality of light emitting dopants may be combined with the host compound and mixed, or a plurality of phosphorescent or fluorescent light emitting materials may be combined to form a plurality of layers (intermediate layers may also be provided). In this manner, the organic EL element of the present invention can be used as a full color display device, and in addition to display, it may be used as a white light source, various emitted light source, a radiation device and the like. In addition, in the case where it is used as a display device for playing moving images, the drive system may either be a simple matrix (passive matrix) system or the active matrix system.

In the present invention, the organic EL element layers are formed on the resin film substrate for organic EL of the present invention, and an object of the present invention is for preventing deterioration of the element of device due to gases such as water vapor or oxygen in the surrounding environment, but a specific embodiment of the production of an organic EL device which uses the substrate of the present invention and which has high gas barrier properties and excellent light taking-out efficiency will be described in the following.

<<Organic EL Device Production>>

The method for forming the organic EL element layers the resin film substrate for organic EL of the present invention is described as an example of the method for producing the organic EL device of the present invention.

First the resin film substrate for organic EL which has concavo-convex structures for diffracting or diffusing light on the outermost gas barrier layer shown in FIG. 3 that is shown in the first embodiment is provided a PMMA film as a stress relief layer or an adhesive layer of polymethyl metacrylate oligomer by vacuum deposition according to a method described in WO00/36665 on a substrate PES (polyether sulfon) film (thickness 200 μm) as the resin film. After the film (thickness 200 nm) is formed by polymerization, a silicon oxide film is formed thereon by the atmospheric pressure plasma CVD method and then a PMMA film with a thickness of 400 nm is formed by the same method and then concavities and convexities are formed by being transferred to the surface from a mold in imprint molding. That is to say, by applying heat and pressure by a stainless steel roller that has pre-formed embossing, a repeated pattern is formed in a rectangular lattice with a pitch (cycle) of 300 nm, a diameter of 150 nm and depth of 120 nm. (Due to diffraction, the light taking-out effect in the 530-580 nm region which is the so-called green region is increased.)

For the diffusing structure which is one of the first embodiments, molding is done using an imprint method such that the PMMA film formed on the surface is heated and pressed using a stainless steel roller comprising embossing with a waveform configuration, and a surface that has a random and gentle waveform configuration is formed with a pitch of 3 μm and average height of 500 nm.

At the same time, the diffusion layer of the second embodiment (FIG. 5) is a layer (diffusion layer) which diffracts or diffused light and is provided on a silicon oxide layer as the outermost layer and is one in which synthetic titanium oxide particles (average particle diameter 2.1 μm, refractive index 2.5) are incorporated in a cross-linking fluorine resin (6% MEK solvent; Trade name JN-7228, manufactured by JSR) such that the solid content concentration is 10% and then dispersed, and then hollow silica particles (P-4 manufactured by Catalysts and Chemicals Industry Co., Ltd.) are mixed with about the same amount of the fluorine resin in solid form, and coating and drying was done at 120° C., and then ultraviolet rays were irradiated and thermal curing was further performed at 120° C., and a resin film substrate for organic EL (thickness 3 μm) was thereby formed. The refractive index of the dispersion layer was 1.37.

For the substrate which is the fourth embodiment (FIG. 6), the diffraction structure is formed as described in the foregoing, by forming a surface in which holes with pitch (cycle) of 300 nm, diameter of 150 nm and depth of 120 nm are arranged in a rectangular grid are formed, and then a SiN (silicon nitride) layer with a thickness of 150 nm is formed thereon by the plasma CVD method. The surface that was formed was made into a smooth film with no projections using polishing tape (Number 15000) manufactured by MIPOX. In this substrate, the surface silicon nitride layer had a refractive index of 1.8.

In addition, as described above, the diffusion structure, a surface which has random waveform such that the average pitch is 3 μm, and the average height is 500 nm is formed in the same manner as above on PMMA using a vacuum ultraviolet excimer lamp, and a substrate in which a silicon nitride layer is formed is produced in the same manner.

The substrate of the fifth embodiment, was formed in the same manner as in the fourth embodiment except that in addition to stress relief layer formed of PMMA which has a diffracting structure on the surface, the layer (diffusion layer) which diffracts or diffuses light is one in which synthetic titanium oxide particles (average particle diameter 2.1 μm, refractive index 2.5) are incorporated in a cross-linking fluorine resin (6% MEK solvent; Trade name JN-7228, manufactured by JSR) such that the solid content concentration is 10%, and then dispersion is performed, and then hollow silica particles (P-4 manufactured by Catalysts and Chemicals Industry Co., Ltd.) are mixed with about the same amount of the fluorine resin in solid form then coated, and drying was done at 120° C., and then ultraviolet rays were irradiated, and thermal curing was further performed at 120° C., and a layer (thickness 3 μm) was thereby formed. As a result, the refractive index of the diffusion layer was 1.37. It has a silicon nitride layer (refractive index 1.8) with a thickness of 100 nm at the outermost layer.

The substrate which is the sixth embodiment in which the two stress relief layers (PMMA, 200 nm) and the two gas barrier layers (silicon oxide, 200 nm) are formed alternately. And as a layer (dispersion layer) which diffracts or diffused light, there is formed on the second gas barrier layer a layer in which synthetic titanium oxide particles (average particle diameter 2.1 μm, refractive index 2.5) are incorporated in a cross-linking fluorine resin (6% MEK solvent; Trade name JN-7228, manufactured by JSR) such that the solid content concentration is 10% and then dispersed, and then hollow silica particles (P-4 manufactured by Catalysts and Chemicals Industry Co., Ltd.) are mixed with about the same amount of the fluorine resin in solid form then coated, and then drying was done at 120° C., and then ultraviolet rays were irradiated, and thermal curing was further performed at 120° C. And thereby, a resin substrate for organic EL (thickness 3 μm) was formed. The refractive index of the dispersion layer was 1.37.

As described above, SiN (silicon nitride) with a thickness of 200 nm is formed using the plasma CVD method in the same manner as above and this is used as the gas barrier layer.

An ITO film is produced by bias sputtering using the sputtering method on the resin film substrates for organic EL formed in the manner described above (thickness 150 nm, refractive index 2.0 and sheet resistance approximately 10 Ω/m²), and after formation of the ITO film, the surface was polished to be a smooth film by about 10 nm using polishing tape (polishing tape number 15000 manufactured by MIPOX).

Organic compound films of a hole injection layer, positive hole transport layer, light emitting layer, electron transport layer, and electron injection layer which are the element materials are formed on anode comprising the ITO film that was formed above.

That is to say, the resin film substrate for organic EL that has an ITO film which includes the light taking-out structure obtained above is fixed in the substrate holder of the vacuum deposition device, and α-NPD for example which is the hole injection/transport layer; and CBP and Ir-12, for example, which are the light emitting host and the light emitting layer dopant respectively as well as the hole blocking layer material BCP and the electron transport layer material Alq₃ are successively put in the resistance heating boat made of tantalum, and the pressure of the vacuum tank was reduced to 4×10⁻⁴ Pa, and the boat is heated, and the material for each layer was sequentially deposited on the substrate at a deposition rate of 0.1 nm/second-0.2 nm/second. The proportions of CBP which is the light emitting host and the light emitting dopant are suitably adjusted by the deposition rate. Next, a cathode buffer layer is provided, and then aluminum, for example, is deposited as the cathode material such that the film thickness is 150 nm, and thereby the cathode is produced, and the organic EL element is completed.

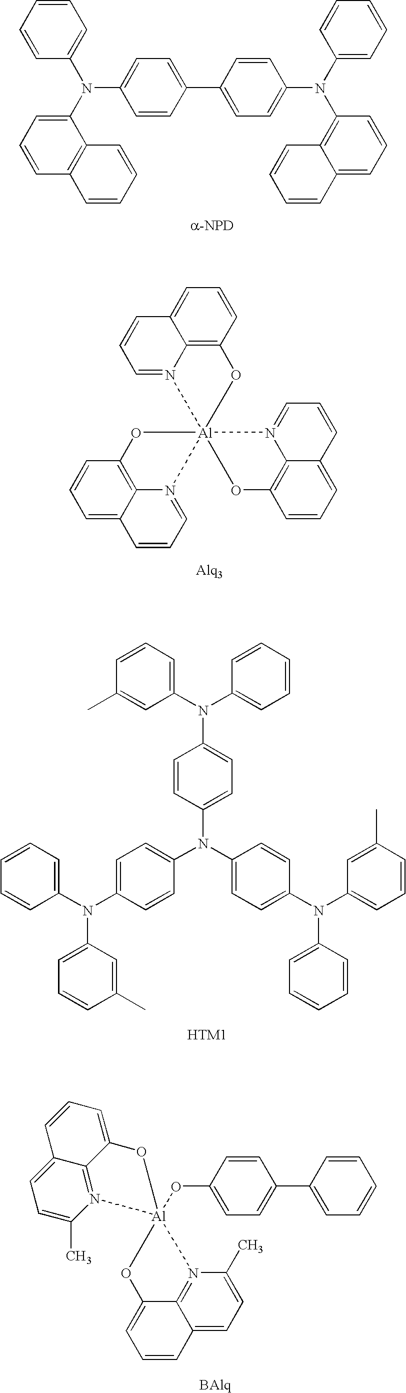

When voltage of about 2-40V is applied to the organic EL device obtained by forming the organic EL element in this manner on the resin film substrate for organic EL of the present invention, light emission can be observed. Regarding the devices having diffracting structure or the diffusing structure or the diffusing layer for improving the light taking-out efficiency, all have improved light taking-out efficiency compared to those which do not have them, and thus emitted light brightness is improved. In addition, by including the barrier layer, gas permeation through the substrate is controlled, and thus deterioration of the organic EL element due to the effect of moisture and gases such as oxygen is prevented.

By using the resin film substrate of the present invention as the substrate at the light taking-out side, the organic EL device can be sealed from moisture and harmful gases such as oxygen. That is to say, once the organic EL element is formed on the transparent substrate of the present invention, another gas barrier film is attached to the substrate from the side that contacts the cathode, and they can be adhered to seal at a portion in the area where the organic EL element of the substrate is not formed. As a result, the service life of the organic EL device can be further increased. FIG. 8 schematically shows an example of the cross-sectional structure of the organic EL device in which an organic EL element is formed on the resin film substrate for organic EL of embodiment 1 and sealed.

Here, anode (ITO) 5, organic EL layers 6 and cathode 7 are provided on the resin film substrate for organic EL of the present invention in which in which a stress relief layer 4, a gas barrier layer 3 as well as a stress relief layer 4 which has a diffraction structure on its surface are sequentially formed on the resin film substrate 1 and another gas barrier film 8 is adhered to seal the resin film substrate periphery using the adhesive 9 to thereby have structure with more items. It is to be noted that the arrow shows the direction of light taking-out.

Another sealing material (gas barrier film) used is a different film which includes a gas barrier layer such as known gas barrier films used in packaging material, and examples include those in which silicon oxide or aluminum oxide is deposited on a plastic film and a gas barrier film and the like in which a dense ceramic layer and a flexible shock absorbing polymer layer are alternately laminated. Also, a metal foil that has been resin-laminated (by polymer films) may not be used as the gas barrier film for the light taking-out side, but it is favorable as a sealing film because that is low in cost and has low moisture permeability. Because the resin film substrate for organic EL of the present invention is transparent and can be used as the gas barrier film for the light taking-out side, even if the other sealing material does not transmit light for example, provided that the material has a low gas permeation rate it can be used.

In the case where a resin film substrate for organic EL according to another embodiment which has a barrier layer or in which a diffusion layer as well as a barrier layer is, by using these substrates as the light taking-out side substrate in replacement of the resin film substrate of embodiment 1, light taking-out efficiency can be improved, and an organic EL device which is sealed from harmful gases can be obtained simultaneously.

1-7. (canceled)

8. A resin film substrate for an organic electroluminescence device, comprising:
a resin film; and
at least one layer on the resin film, the at least one layer including a gas barrier layer,
wherein an outermost layer on a gas barrier side of the resin film includes on a surface thereof a concavo-convex structure for diffracting or diffusing a light lay.

9. A resin film substrate for an organic electroluminescence device, comprising:
a resin film; and
at least one layer on the resin film, the at least one layer including a gas barrier layer,
wherein an outermost layer on a gas barrier side of the resin film includes a layer for diffracting or diffusing a light lay.

10. The resin film substrate for the organic electroluminescence device of claim 8, wherein the outermost layer of the gas barrier layer side of the resin film includes a layer whose refractive index is greater than or equal to 1.03 and less than or equal to 1.50 and whose thickness is greater than or equal to 0.3 μm.

11. A resin film substrate for an organic electroluminescence device, comprising:
a resin film;
at least one layer on the resin film; the at least one layer including a gas barrier layer, and
a concavo-convex structure for diffracting or diffusing a light lay between an outermost layer of the gas barrier side of the resin film and an adjacent layer thereto,
wherein the outermost layer of the gas barrier layer side of the resin film includes a layer whose refractive index is greater than or equal to 1.45 and less than or equal to 2.10.

12. A resin film substrate for an organic electroluminescence device, comprising:
a resin film;
at least one layer on the resin film, the at least one layer including a gas barrier layer, and
a layer for diffracting or diffusing a light lay on an outermost surface of the gas barrier side of the resin film,
wherein the outermost layer of the gas barrier layer side of the resin film includes a layer whose refractive index is greater than or equal to 1.45 and less than or equal to 2.10.

13. The resin film substrate for the organic electroluminescence device of claim 11, wherein a layer adjacent to the outermost layer of the gas barrier layer side of the resin film includes a layer whose refractive index is greater than or equal to 1.03 and less than or equal to 1.50.

14. An organic electroluminescence device, comprising:
a resin film substrate; the resin film substrate including: a resin film; and
at least one layer on the resin film, the at least one layer including a gas barrier layer,
an organic electroluminescence layer; and
a metal electrode on the organic electroluminescence layer,
wherein an outermost layer on a gas barrier side of the resin film includes on a surface thereof a concavo-convex structure for diffracting or diffusing a light lay.

15. The resin film substrate for the organic electroluminescence device of claim 9, wherein the outermost layer of the gas barrier layer side of the resin film includes a layer whose refractive index is greater than or equal to 1.03 and less than or equal to 1.50 and whose thickness is greater than or equal to 0.3 μm.

16. The resin film substrate for the organic electroluminescence device of claim 12, wherein a layer adjacent to the outermost layer of the gas barrier layer side of the resin film includes a layer whose refractive index is greater than or equal to 1.03 and less than or equal to 1.50.
